(19) United States
(12) Patent Application Publication
(10) Pub. No.: US 2010/0180771 A1
(43) Pub. Date: Jul. 22, 2010

(54) FLUIDIZED BED SYSTEM FOR REMOVING MULTIPLE POLLUTANTS FROM A FUEL GAS STREAM

(75) Inventors: Ke Liu, Rancho Santa Margarita, CA (US); Vladimir Zamansky, Oceanside, CA (US)

Correspondence Address: GENERAL ELECTRIC COMPANY;GLOBAL RESEARCH, ONE RESEARCH CIRCLE, BLDG. K1-3A59, NISKAYUNA, NY, 12309, US

(73) Assignee: GENERAL ELECTRIC COMPANY, SCHENECTADY, NY (US)

(21) Appl. No.: 12/357,765

(22) Filed: Jan. 22, 2009

(51) Int. Cl. B01D 53/18; B01J 20/00; B01J 20/02; B01J 20/04; B01J 20/08; B01J 20/10; B01J 20/18

(52) U.S. Cl. 96/141; 96/108; 96/143; 502/400; 502/60; 502/64; 502/74; 502/406; 502/407; 502/415

(57) ABSTRACT

A system includes an adsorber having a fluidized bed of a plurality of adsorption materials. The adsorber is configured to receive the gaseous fuel stream including the plurality of pollutants and adsorb the said plurality of pollutants in a single unit from the gaseous fuel stream to generate a clean gas stream substantially free of the pollutants. Different adsorption materials are designed to remove different pollutants over a similar temperature range. The pollutants include at least one of sulfur compounds, chlorine, ammonia, mercury, arsenic, selenium, cadmium, or combinations thereof.

### BACKGROUND

The invention relates generally to adsorption system, and more particularly to an adsorber for removing multiple pollutants in a single unit from a fuel gas stream, for example, syngas stream generated from a coal and biomass gasifier for an Integrated Gasification Combined Cycle (IGCC) plant.

It is known that industrial fuel gases generated from coal or petroleum contain multiple pollutants including sulfur compounds, chlorine, ammonia, mercury, arsenic, or the like. One such fuel gas, synthesis gas (syngas), is produced by either reforming or gasifying a carbonaceous fuel by contacting it with an oxidant under high temperature conditions to produce a fuel gas containing hydrogen and carbon monoxide. In recent years, substantial research and investment has been directed towards various syngas processes, such as coal, biomass, and waste gasification or homogeneous or catalytic partial oxidation of different fuels for generating syngas. Syngas can be used as a feed in a power plant for the generation of energy in an IGCC plant, raw material for generation of high-value chemicals or transportation fuels, and as a hydrogen source for fuel cells. Multiple pollutants in the syngas from a coal gasifier have to be removed before feeding to down-stream processes for protecting the catalysts used in down-stream processes or to a gas turbine for reducing emissions.

In the conventional approach to remove pollutants, multiple cooling steps of the syngas are needed to cool the syngas stream to a room temperature before the syngas stream is fed to a Acid Gas Removal (AGR) unit referred to generally as “syngas clean-up system”. For example, the syngas may be cooled from 1350 degrees Celsius to 500 degrees Celsius to remove particulates, and then further cooled to 250 degrees Celsius to remove chlorine. The gas may then be further cooled to 90 degrees Celsius for carbonyl sulfide hydrolysis. The gas may again be further cooled to 45 degrees Celsius for removing hydrogen sulfide, and carbon dioxide if required, using amine so as to obtain a clean syngas between a gasifier and a gas turbine. However, cooling of a fuel gas stream, such as syngas in multiple steps, increases the capital cost of the plant (CAPEX), and also reduces the thermal efficiency of the process often making this processing technology less advantageous. Amine-based scrubbing processes also have problems such as the formation of heat stable salts, decomposition of amines, and are additionally equipment-intensive, thus requiring substantial capital investment.

After the syngas is cleaned at a lower temperature, the syngas stream is reheated to a predetermined temperature, for example 350 degrees celsius before feeding to down-stream chemical processes or a gas turbine. The multiple cooling and reheating steps reduces the efficiency and increases the cost of a plant.

It is desirable to have a simple and efficient system for removing multiple pollutants from a fuel gas stream, for example syngas stream at a higher temperature.

### BRIEF DESCRIPTION

In accordance with an exemplary embodiment of the present invention, a system for removing a plurality of pollutants from a gaseous fuel stream is disclosed. The system includes an adsorber having a fluidized bed of a plurality of adsorption material. The adsorber is configured to receive the gaseous fuel stream including the plurality of pollutants and adsorb the plurality of pollutants in a single unit from the gaseous fuel stream to generate a clean fuel gas stream substantially free of the pollutants. The pollutants include at least one of sulfur compounds, chlorine, ammonia, mercury, arsenic, selenium, cadmium, or combinations thereof.

In accordance with another exemplary embodiment of the present invention, an adsorber includes a first fluidized bed of a plurality of adsorption material. The adsorber is configured to receive the gaseous fuel stream including a plurality of pollutants, and adsorb the plurality of pollutants in a single unit from the gaseous fuel stream to generate a clean gas stream substantially free of pollutants. The pollutants include sulfur, chlorine, ammonia, mercury, arsenic, selenium, cadmium, and compounds of sulfur, chlorine, ammonia, mercury, arsenic, selenium, cadmium, or combinations thereof. A regenerator is fluidically coupled to the adsorber. The regenerator includes a second fluidized or transport bed configured to receive an oxidant. The oxidant is contacted with the adsorption material to regenerate the adsorption material after adsorption capacity of the adsorption material is completely or partially saturated.

In accordance with another exemplary embodiment, an adsorption material includes least one metal selected from the group consisting of zinc, magnesium, molybednum, manganese, iron, chromium, copper, cobalt, celium, nickel, tungsten, silver, titanium, vanadium, aluminium, zeolite, niobium, or combinations thereof dispersed or impregnated on a plurality of porous particle supports, which are produced from a spray drying process. Porous particles include oxides of calcium, zinc, iron, magnesium, alumina, silica, zinc titanate, zinc aluminate, calcium aluminate, or combinations thereof. The adsorber is configured to remove a plurality of pollutants in a single unit from a gaseous fuel stream to generate a clean gas stream substantially free of pollutants.

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatical view of a system configured for removing a plurality of pollutants from a gaseous fuel stream in a single unit in accordance with an exemplary embodiment of the present invention; and

FIG. 2 is a diagrammatical view of an exemplary synthesis gas production system integrated with a system configured for removing a plurality of pollutants from a gaseous fuel stream in a single unit in accordance with an exemplary embodiment of the present invention.

### DETAILED DESCRIPTION

As discussed in detail below, embodiments of the present invention provide a system for removing a plurality of pollutants from a syngas or a gaseous fuel stream. The system includes an adsorber including a fluidized bed of a plurality of adsorption materials configured to receive a syngas or a gaseous fuel stream having a plurality of pollutants. The plurality of adsorption materials is designed to adsorb different pollutants over a similar temperature range. The adsorber is configured to adsorb the plurality of pollutants in a single unit from the syngas or the gaseous fuel stream to generate a clean gas stream substantially free of the pollutants. The pollutants may include at least one of compounds of sulfur, chlorine, ammonia, mercury, arsenic, selenium, cadmium, or combinations thereof. In certain embodiments, a regenerator is fluidically coupled to the adsorber. The regenerator includes a fluidized or transport bed configured to receive an oxidant to contact with an adsorption material to regenerate the adsorption material. As discussed herein, the exemplary system provides a single unit clean-up process for removing a plurality of pollutants from the syngas or the gaseous fuel stream. Existing catalyst plants that include spry drying processes for FCC (Fluid Catalytic Cracking) catalyst production may be used to produce the fine adsorption particles cheaply via the spry drying process. Hence additional investment may not be required for building new plants to produce such exemplary type of adsorbents.

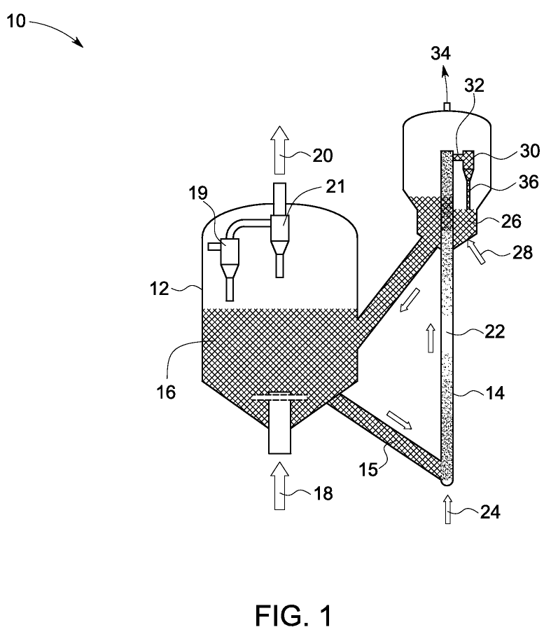

Referring to FIG. 1, an exemplary system 10 for removing a plurality of pollutants from a gaseous fuel stream in a single unit is illustrated. The system 10 includes an adsorber 12 and a regenerator 14. The adsorber 12 is fluidically coupled to the regenerator 14 via a conduit 15. The adsorber 12 includes a first fluidized bed 16 configured to receive a gaseous fuel stream 18 having a plurality of pollutants. The pollutants may include sulfur, chlorine, ammonia, mercury, arsenic, selenium, cadmium, compounds of the pollutants discussed herein, or combinations thereof. The sulfur compounds may include but not limited to hydrogen sulfide, carbonyl sulfide. The first fluidized bed 16 includes different types of adsorption materials configured to adsorb the plurality of pollutants in a single unit from the gaseous fuel stream 18 and generate a clean gas stream 20 substantially free of the pollutants. A cyclone separator having two stages 19, 21 is provided to a top of the adsorber 12 to separate the adsorption particles from cleaned gas stream. The adsorption particles carried by the clean gas stream 20 are separated from the stream 20 via the cyclone separator having two stages 19, 21. The two stage closed cyclone separator may also be provided outside the adsorber 12. The adsorption particles are dropped back to a third fluidized bed 26 via a conduit 36.

In one embodiment, the adsorption material includes porous particles including oxides of calcium, zinc, iron, magnesium, alumina, silica, or zinc titanate, zinc aluminate, calcium aluminate, or combinations thereof. The size of particles of the adsorption material may be in the range from about 30 microns to about 1000 microns. In a specific embodiment, the adsorption material includes at least one metal selected from the group consisting of zinc, magnesium, molybednum, manganese, iron, chromium, copper, cobalt, celium, nickel, tungsten, silver, titanium, vanadium, aluminum, zeolite, niobium, or combinations thereof dispersed or impregnated on spray-dried porous particle support using alumina binders. Binders are used to generate porosity in the porous particles. In one embodiment, at least one metal is mixed with porous particle support by physical mixing. In another embodiment, at least one metal is mixed with the porous particle support by ion-exchange process. In yet another embodiment, at least one metal is mixed with the porous particle support by wash coating process. In certain embodiments, the adsorption material may be produced by a spray-drying process followed by a calcination process at a temperature in the range of about 500 degrees Celsius to about 1100 degrees Celsius. In a specific embodiment, the calcination temperature may be in the range of about 700 degrees Celsius to about 900 degrees Celsius.

In some embodiments, the usage of alumina or silica binder along with spray drying facilitates to control the size, porosity, surface area and strength of the porous adsorption particles. In a specific embodiment, to produce the exemplary adsorption particles, an organic or inorganic binder is used along with water and a surfactant to produce a slurry. The metal precursor is added to the slurry and the slurry is then spray dried and heated. The particles are subsequently calcined to provide more attrition resistance property for the adsorption material.

In certain embodiments, the gaseous fuel stream may be selected from a group including methane, ethane, propane, butane, a mixture of petroleum gases, vapor of liquefied petroleum gas, naphtha, gasoline, diesel, kerosene, an aviation fuel; syngas stream produced from reforming of natural gas or naphtha, syngas stream from gasification of coal, petroleum coke, bio-mass, waste or heavy oil, gas oil, crude oil, an oxygenated hydrocarbon feedstock, or combinations thereof. In a more specific embodiment, the gaseous fuel stream may include a syngas produced from gasification of solid and/or liquid fuels comprising coal, biomass, waste, oil, or combinations thereof. In certain other embodiments, the gaseous fuel stream may include synthesis gas produced from a gasifier for an integrated combined cycle power plant. The synthesis gas typically includes hydrogen, carbon monoxide, carbon dioxide, and steam. In some embodiments, the temperature of the gaseous fuel stream 18 may be in the range from about 100 degrees Celsius to about 350 degrees Celsius. The adsorber 12 may be operated at a temperature in the range from about 150 degrees Celsius to about 550 degrees Celsius, and preferably in the range of 200 degrees Celsius to 400 degrees Celsius.

The regenerator 14 includes a second fluidized bed 22 configured to receive the saturated or partially saturated adsorption material from the adsorber 12 and an oxidant 24. The oxidant is contacted with the adsorption material from the adsorber 12 to regenerate the adsorption material. The temperature in the regenerator 14 is in the ranges from about 350 degrees Celsius to about 950 degrees Celsius. The system 10 further includes the third fluidized bed 26 in fluid communication with the first fluidized bed 16 and the second fluidized bed 22. The third fluidized bed 26 is configured to receive steam 28 to regenerate the saturated adsorption material from the adsorber 12. The second fluidized bed 22 is typically a dilute bed having a low density of particulates and the third fluidized bed 26 is typically a dense bed having a high density of particulates. In operation, the fluidized beds 22 and 24 are configured to receive the saturated adsorption material from the first fluidized bed 16 and the oxidant 24 to regenerate the adsorption material. The pressure of the oxidant 24 maintains the second fluidized bed 22 at a required fluidized condition. Additionally, a two-stage closed cyclone separator 30 is coupled to the regenerator 14 via a conduit 32. The oxidant 24 reacts with the adsorption material to generate an oxygen-depleted stream 34. The adsorption material particles carried by the oxygen-depleted stream 34 are separated from the stream 34 via the two-stage closed cyclone separator 30. The separated adsorption material particles are fed back to the third fluidized bed 26 via a conduit 36.

The types of fluidized bed that can be used herein include fast fluid beds and circulating fluid beds. The circulation of the exemplary adsorption material can be achieved in either the up-flow or down-flow modes. A circulating fluid bed is a fluid bed process whereby adsorption materials are continuously removed from the bed (whether in up flow or down flow orientation) and are then re-introduced into the bed to replenish the supply of solids. At lower velocities, when the adsorption material is still entrained in the gas stream, a relatively dense bed is used in the system 10 for removal of the entrained adsorption material.

As discussed earlier, in the conventional approach to remove pollutants, multiple cooling steps of the syngas are done. However, cooling of a fuel gas stream, such as syngas in multiple steps, reduces the thermal efficiency of the process often making this process less advantageous. Amine-based scrubbing processes also have problems such as the formation of heat stable salts, decomposition of amines, and are additionally equipment-intensive, thus requiring substantial capital investment. In accordance with the exemplary embodiment of the present invention, FCC catalyst plants can be readily utilized to produce the exemplary adsorption particles. Different adsorption particles are used in the exemplary adsorber 12 to clean-up different pollutants from the gaseous fuel stream in a single unit. For example, a zinc oxide component is designed for removing sulfur; certain alkali metal oxides are designed for removing chlorine, and so forth. Certain high surface area materials are designed for removing mercury and trace metal (for example, arsenic or selenium).

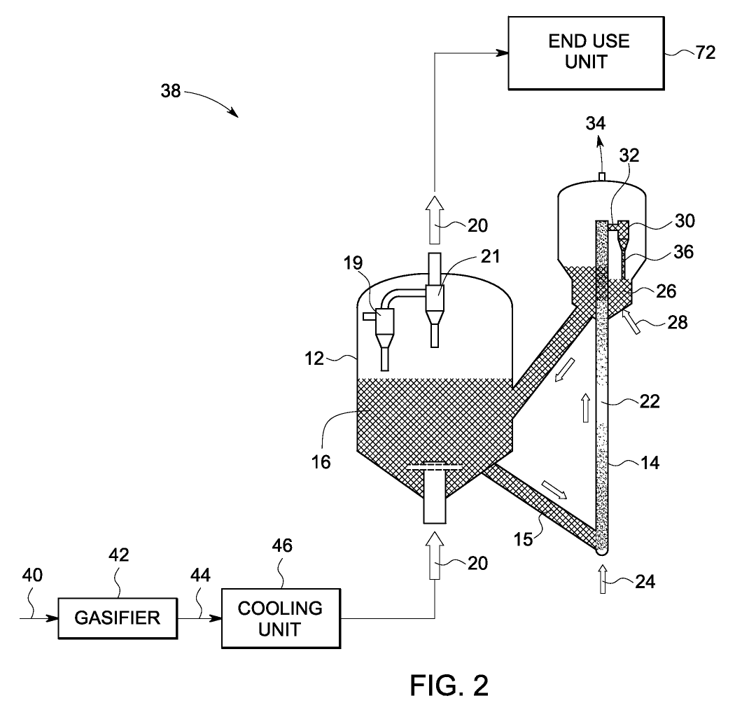

Referring to FIG. 2, an exemplary system 38 for removing a plurality of pollutants from a gaseous fuel stream in a single unit is illustrated. A fuel 40 is gasified in a gasifier 42, to produce a hot synthesis gas 44. The synthesis gas 44 may be at a temperature in a range of about 1100 degrees Celsius to about 1400 degrees Celsius. The hot synthesis gas 44 is cooled via a cooling unit 46 to cool the temperature of the hot synthesis gas 44 to produce a cooled gaseous fuel stream 20. In certain embodiments, more than one cooling unit may be used. In the illustrated embodiment, the cooled gaseous fuel stream 20 includes the cooled synthesis gas. The cooled synthesis gas 20 is introduced into the adsorber 12 for removing plurality of pollutants from the synthesis gas as described in the preceding embodiment. The clean gas stream from the adsorber 12 is introduced into an end use unit 48. The end use unit 48 may include a power generation plant, coal to chemical plant, coal to liquid plant, natural gas to liquid plant, and a hydrogen generation unit, or combinations thereof. As discussed previously, the pollutants may include sulfur, chlorine, ammonia, mercury, arsenic, selenium, cadmium, compounds of the pollutants discussed herein, or combinations thereof. The efficiency of a plant, for example an integrated combined cycle gasification plant is enhanced by usage of a high temperature single step clean-up technique.

The pollutant removal process contributes towards the capital cost of plants including integrated combined cycle gasification power plants, coal to methanol or hydrogen plants, or any other plants that requires removal of various pollutants from a syngas stream. In these applications, it is not feasible to use multiple removal steps, stop the plant frequently, replace the adsorbent and dispose off the huge amount of adsorbent as chemical waste without regeneration. The exemplary process eliminates multiple cooling steps and unit operations of the conventional pollutant removal systems. The single step pollutant removal process described herein provides a low cost and efficient pollutant removal technique for plants at high temperature, and other applications.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A system for removing a plurality of pollutants from a gaseous fuel stream comprising:
an adsorber comprising a fluidized bed of a plurality of adsorption materials; wherein the adsorber is configured to receive the gaseous fuel stream comprising the plurality of pollutants and adsorb the said plurality of pollutants in a single unit from the gaseous fuel stream to generate a clean fuel gas stream substantially free of the pollutants;
wherein the pollutants comprises at least one of sulfur compounds, chlorine, ammonia, mercury, arsenic, selenium, cadmium, or combinations thereof.

2. The system of claim 1, wherein the adsorption material comprises porous particles produced from a spray drying process; wherein the adsorption material comprises oxides of calcium, zinc, iron, magnesium, alumina, silica, or zinc titanate, zinc aluminate, calcium aluminate, or combinations thereof.

3. The system of claim 1, wherein the adsorption material comprises at least one metal selected from the group consisting of zinc, magnesium, molybednum, manganese, iron, chromium, copper, cobalt, celium, nickel, tungsten, silver, titanium, vanadium, aluminium, zeolite, niobium, or combinations thereof dispersed or impregnated on spray-dried porous particle support.

4. The system of claim 1, wherein the adsorption material is produced by a spray-drying process followed by calcination at a temperature range of about 500 degrees Celsius to about 1100 degrees Celsius.

5. The system of claim 1, wherein particles of the adsorption material is in the range of about 30 microns to about 1000 microns.

6. The system of claim 1, wherein the adsorber is operated at a temperature in the range of about 150 degrees Celsius to about 550 degrees Celsius.

7. The system of claim 1, wherein the sulfur compounds comprises hydrogen sulfide and carbonyl sulfide.

8. The system of claim 1, wherein the gaseous fuel stream is selected from a group consisting of methane, ethane, propane, butane, mixture of petroleum gases, vapor of liquefied petroleum gas, naphtha, gasoline, diesel, kerosene, an aviation fuel; syngas stream produced from reforming of natural gas or naphtha, syngas stream from gasification of coal, petroleum coke, bio-mass, waste, gas oil, crude oil, an oxygenated hydrocarbon feedstock, or combinations thereof.

9. The system of claim 8, wherein said gaseous fuel stream is produced from gasification of solid and/or liquid fuels comprising coal, biomass, waste, oil, or combinations thereof.

10. The system of claim 8, wherein the gaseous fuel stream is used in a power generation plant, coal to chemical plant, coal to liquid plant, natural gas to liquid plant, a hydrogen generation unit, or combinations thereof.

11. A system for removing a plurality of pollutants from a gaseous fuel stream, the system comprising:
an adsorber comprising a first fluidized bed of a plurality of adsorption materials; wherein the adsorber is configured to receive the gaseous fuel stream comprising a plurality of pollutants, and adsorb the said plurality of pollutants in a single unit from the gaseous fuel stream to generate a clean fuel gas stream substantially free of pollutants; wherein the pollutants comprises sulfur, chlorine, ammonia, mercury, arsenic, selenium, cadmium, compounds of sulfur, chlorine, ammonia, mercury, arsenic, selenium, cadmium, or combinations thereof;
a regenerator fluidically coupled to the adsorber; wherein the regenerator comprises a second fluidized or transport bed configured to receive an oxidant; wherein the oxidant is contacted with the adsorption material to regenerate the adsorption material.

12. The system of claim 11, wherein the adsorption material comprises porous particles comprising oxides of calcium, zinc, iron, magnesium, alumina, silica, zinc titanate, zinc aluminate, calcium aluminate, or combinations thereof.

13. The system of claim 11, wherein the adsorption material comprises at least one metal selected from the group consisting of zinc, magnesium, molybednum, manganese, iron, chromium, copper, cobalt, celium, nickel, tungsten, silver, titanium, vanadium, aluminium, zeolite, niobium, or combinations thereof dispersed or impregnated on spray-dried porous particle support using alumina binders.

14. The system of claim 11, wherein the adsorption material is produced by a spray-drying process followed by calcination at a temperature range of about 500 degrees Celsius to about 1100 degrees Celsius.

15. The system of claim 11, wherein the adsorber is operated at a temperature in the range of about 150 degrees Celsius to about 550 degrees Celsius.

16. The system of claim 11, further comprising at least one first two-stage closed cyclone separator in fluid communication with the adsorber.

17. The system of claim 11; further comprising at least one second two-stage closed cyclone separator in fluid communication with the regenerator.

18. The system of claim 11, wherein the oxidant comprises air, oxygen depleted air, oxygen enriched air, or combinations thereof.

19. The system of claim 11, wherein the fuel gas stream comprises synthesis gas generated from a gasifier.

20. The system of claim 19, wherein the synthesis gas is produced by gasification of coal, petroleum coke, biomass, waste or heavy oil.

21. An adsorber, comprising:
a plurality of adsorption materials comprising least one metal selected from the group consisting of zinc, magnesium, molybednum, manganese, iron, chromium, copper, cobalt, celium, nickel, tungsten, silver, titanium, vanadium, aluminium, zeolite, niobium, or combinations thereof dispersed or impregnated on a plurality of porous particle support;
wherein porous particles comprises oxides of calcium, zinc, iron, magnesium, alumina, silica, zinc titanate, zinc aluminate, calcium aluminate, or combinations thereof.
wherein the adsorber is configured to remove a plurality of pollutants in a single unit from a gaseous fuel stream to generate a clean gas stream substantially free of pollutants.

22. The adsorber of claim 21, wherein the adsorption material comprises at least one metal selected from the group consisting of zinc, magnesium, molybednum, manganese, iron, chromium, copper, cobalt, celium, nickel, tungsten, silver, titanium, vanadium, aluminium, zeolite, niobium, or combinations thereof dispersed or impregnated on spray-dried porous particle support using alumina or silica binders.

23. The adsorber of claim 22, wherein alumina or silica binders are configured to provide porosity and strength to porous particle supports.

24. The adsorber of claim 21; wherein the at least one metal is dispersed or impregnated with the plurality of porous particles by physical mixing, ion exchange process, wash-coating process, or combinations thereof.

25. The system of claim 21, wherein the adsorption material is produced by a spray-drying process followed by calcination at a temperature range of about 500 degrees Celsius to about 1100 degrees Celsius.
